(19) United States
(12) Patent Application Publication
(10) Pub. No.: US 2026/0035517 A1
(43) Pub. Date: Feb. 5, 2026

(54) PEROXIDE PRE-TREATMENT COMBINED WITH AN ESTERIFICATION OF LIGNIN-DERIVED MATERIAL

(71) Applicant: SixRing Inc., Calgary (CA)

(72) Inventors: Matthew Dewit, Calgary (CA); Markus Weissenberger, Calgary (CA)

(21) Appl. No.: 19/044,226

(22) Filed: Feb. 3, 2025

(30) Foreign Application Priority Data
Aug. 2, 2024 (CA) 3250829

(51) Int. Cl. C08H 7/00

(52) U.S. Cl. CPC C08H 6/00

(57) ABSTRACT

A method for converting a lignin-derived material into at least one esterified lignin derivative, the method including the steps of: providing the lignin-derived material selected from the group of lignin monomers, lignin depolymerization products, and combinations thereof; adding a strong acid such as, sulfuric acid; providing an amount of peroxide component in quantity sufficient to obtain up to a 1:1 mole ratio with the strong acid; adding the peroxide component to the lignin-derived material and the strong acid to allow an oxidation reaction to take place for a pre-determined period of time sufficient to yield a composition comprising a pre-treated lignin-derived material; wherein the pre-treated lignin-derived material comprises at least one oxidized specie; and performing an esterification reaction on the composition comprising a pre-treated lignin-derived material, the esterification reaction including the steps of: providing an acidic composition having a pH of less than 1, the acidic composition including an acid selected from sulfuric acid, an alkylsulfonic acid, and an arylsulfonic acid, and an alcohol selected from C₁-C₈ linear alcohol and C₃-C₈ branched alcohol and mixtures thereof; combining the pre-treated lignin-derived material with the acidic composition into an esterification reaction mixture; heating up the esterification reaction mixture to a temperature ranging from 25° C. to 120° C.; and allowing sufficient time for an esterification reaction to occur to yield an esterified composition comprising the at least one esterified lignin derivative; wherein the esterified composition has an average molecular weight of less than 4000, as determined by gel permeation chromatography.

### CROSS REFERENCE TO RELATED APPLICATIONS

The current application claims priority to Canadian Application No. 3,250,829 filed Aug. 2, 2024 and titled PEROXIDE PRE-TREATMENT COMBINED WITH AN ESTERIFICATION OF LIGNIN-DERIVED MATERIAL, the contents of which are incorporated by reference in their entirety.

### FIELD OF THE INVENTION

The present invention is directed to a method of converting lignin from biomass into valuable smaller chemicals, more specifically, in one instance, there is provided a method to convert lignin-derived material obtained from a modified Caro's acid delignification process into small valuable chemicals.

### BACKGROUND OF THE INVENTION

Petroleum is the cornerstone of the present chemical industry. Not only is it the most commonly used fuel in transportation, heating oils and electricity generation but it is also the primary raw material for the overwhelming majority of the basic chemicals used in plastics, adhesives and whole variety of synthetic materials just to name a few. The ever-growing demands and limits of the availability of this non-renewable resource is forcing the chemical industry to increase their research on the use of renewable resources as an alternative to petroleum.

Lignocellulosic biomass such as, but not limited to wood, grasses and other plant materials, contains three main components: cellulose fibers; lignin; and hemicelluloses. Pulping of lignocellulosic biomass has a primary goal to separate the fibers from the lignin. Lignin is a three-dimensional polymer which figuratively acts as a mortar to hold all the fibers together within the plant. Its presence in finished pulp is undesirable and adds nothing to the finished product.

Lignin accounts for, in some biomass, up to 30 percent of the lignocellulose biomass (for some biomass the lignin content can reach up to 40%), and has a great potential to replace at least a portion of the petroleum-based chemical products. However, it is still greatly underused as such an alternative. Lignin is the second most abundant organic natural material encountered in nature. However, approximately 98% of it is still simply burned to provide heat or used in the production of energy.

Lignin is made up of various aromatic compounds and its complexity comes from the diversity and degree of crosslinking between the various monomeric units which comprises it. These are called lignolsand fall under one of three main categories: coniferyl alcohol; sinapyl alcohol; and paracoumaryl alcohol.

Aromatic compounds are normally extracted from petroleum and can be used in the production of a variety of high value products including but not limited to adhesives, drugs and paints. Consequently, the potential value locked up in lignin and its various monomeric constituents is quite high as it is the only naturally occurring source of such a large number of aromatic compounds.

The depolymerization of lignin into its various constituent monomeric building blocks is a major focus of several research groups as the subsequent uses of those monomers can open the doorway to a multitude of plant-derived chemical products. The yields of the lignin-originating aromatic monomers are largely dependent on the delignification method employed as well as the biomass used. Not all biomasses contain the same lignin content. Further, since lignin is a highly complex biopolymer, its origination from different biomasses means that the ratio of the lignin-originating aromatic monomers will vary from plant to plant.

The isolation of the individual lignin-originating aromatic monomers from complex mixtures following delignification of biomass is still a substantial challenge to the industry. Lignin condensation is a particular challenge which hinders the isolation of lignin constituents. The current lignin depolymerization techniques include alkaline oxidation, fast pyrolysis (used to maximize the liquid bio-oil product yield), hydrogenolysis, and hydrolysis.

European patent application EP2025735A1 teaches a one-step conversion of solid lignin to liquid products. More specifically, a method of converting a lignin material into a liquid product by treatment in a reaction medium comprising at least one C1-C2 carboxylic acid and the liquid product obtainable by the method.

U.S. Pat. No. 9,663,835B2 discloses a process and system for the efficient fractionation of lignocellulosic biomass into cellulose, hemicellulose sugars, lignin, and acetic acid. It states that the cellulose thus obtained is highly amorphous and can be readily converted into glucose using known methods. Fermentable hemicellulose sugars, low-molecular-weight lignin, and purified acetic acid are also major products of the process and system.

United States patent application US 2010/0121110A1 discloses a method for the breakdown of lignin which teaches a method for the direct production of molecules with a minimum molecular weight of 78 g/mol by the breakdown of lignin, lignin derivatives, lignin fragments, and/or lignin-containing substances or mixtures in the presence of at least one polyoxometallate and preferably in the presence of a radical scavenger in a liquid medium.

Japanese patent application JP2015089884A teaches a method for producing lignin monomers with high yield by decomposing a plant material containing a lignin component such as wood using a reaction agent which is easily available and has no problem with handleability. The method for producing lignin monomers uses a step of irradiating a mixture with microwave of a plant material containing a lignin component and a metal compound to decompose the plant material.

United States patent application US 2013/0232853A1 discloses a method of production of biobased chemicals, biofuels, and lignin residues from lignin sources, including waste lignin. This method may allow for selectively producing biobased chemicals, biofuels, and lignin residues from lignin sources using certain processing methods. The methods for production of these biobased chemicals, biofuels, and lignin residues may be provided by chemical-induced processing, catalytic oxidative lignin depolymerization processing, and catalytic hydroprocessing. Further, the catalytic hydroprocessing from processes including catalytic reduction processing, catalytic hydrodeoxygenation processing, and/or catalytic/dehydrogenation processing may also be used. The method described herein also provides a means in which waste from the process(es) may be reduced and/or recycled.

United States patent application US2016/0130202A1 discloses methods for the production and isolation of a monomer from a biopolymer. The method includes extracting a biopolymer from a biopolymer source and depolymerizing the biopolymer into a monomer. Also disclosed are methods for the production and isolation of a monomer from corn lignin.

Because of the heterogeneity of lignin and the substantial issues caused by the condensation of lignin monomers, there has not been a satisfactory approach to extract lignin from biomass and to further convert the extracted lignin to value added chemicals. Alkali lignin is particularly susceptible to condensation reaction. Since alkaline pulping represents the most widespread delignification and pulping processes across the world, the majority of the lignin thus extracted is not salvageable for further chemical processes and is typically used as a source of heat as it is simply burned.

One of the drawbacks of the lignin obtained through a kraft delignification or through the sulfite process is largely still polymerized and thus will not be useful in generating small molecules. Pyrolysis, on the other hand, is a method to produce lignin-derived molecules from lignocellulosic biomass.

Conventional pyrolysis oil generates aldehydes which can polymerize over time and thus render such bio-oil unstable over time. Most bio-oils generated from pyrolysis have the same drawbacks. Their delignification process yields bio-oil which contains aldehydes, their aldehyde content makes themunstable for long-term storage. Pyrolysis oil also has other drawbacks which include: having a high oxygen content (making less desirable for combustion in engines); they are largely non-volatile; and they may be corrosive.

In light of the state of the art, there still exists a need for the valorization of lignin and lignin-derived materials, more specifically for a method capable of converting lignin depolymerization products into higher value chemicals.

### SUMMARY OF THE INVENTION

LHDO obtained from delignification of lignocellulosic biomass material using a modified Caro's acid, overcomes the problem caused by the presence of aldehyde by circumventing the production thereof. The oxidizing power of modified Caro's acid used favors the production of carboxylic acids and allows to achieve complete or very near to complete oxidation of the LHDO. Upon analysis, the aldehyde levels are below detection limits. According to a preferred embodiment of the present invention, the LHDO comprises lignin-derived material selected from the group consisting of: lignin monomers (20 to 50 wt. % of said lignin-derived material); lignin depolymerization products (50 to 80 wt. % of said lignin-derived material), wherein lignin depolymerization product is not a monomer but a soluble lignin-derivative, i.e. a breakdown compound.

However, difficulties arose when wanting to extract the lignin depolymerization products present in the liquid recovered from a modified Caro's acid-driven delignification of biomass material. The various lignin monomers obtained from such a process were found to be hydrophilic and thus miscible with the remaining sulfuric acid present in the liquid recovered.

According to an aspect of the present invention, the inventors have developed a method which overcomes the difficulties caused by the presence of a strong acid, inorganic impurities (such as sulfate salts, chlorides) and water in the liquid recovered but can also allow for the synthesis of various diester compounds and facilitate the recovery of such from a stream containing lignin depolymerization compounds as well as dissolved hemicellulose. It was surprisingly and unexpectedly discovered that a mixture of valuable aromatic and aliphatic esters could be produced from lignin-originating aromatic monomers obtained from the delignification of biomass performed using a modified Caro's acid (i.e. H₂SO₄, in the presence of a modifier and a source of peroxide).

According to one aspect of the present invention, there is provided a method to convert lignin-derived material (i.e. lignin depolymerization products comprising: lignin oligomers; and lignin monomers) into smaller molecules which are considered more valuable. According to a preferred embodiment of the present invention, the lignin-derived material obtained through the delignification of lignocellulosic feedstock (or biomass) by the methods and process disclosed herein include but are not limited to: lignin monomers; lignin depolymerization products such as: vanillic acid; malonic acid; maleic acid; succinic acid; oxalic acid; and 4-hydroxybenzoic acid. Preferably, the lignin-derived material forms part of the solubilized lignin and hemicellulose depolymerized organics (LHDO) stream resulting from a delignification of a lignocellulosic biomass through the use of a modified Caro's acid. Preferably, said lignin-hemicellulose depolymerized organics (LHDO) is a composition comprising: a strong acid and said lignin-derived material; said lignin-derived material comprises: lignin monomers (20 to 50 wt. %); lignin depolymerization products (50 to 80 wt. %).

According to an aspect of the present invention there a method for converting a LHDO composition comprising a lignin-derived material into at least one esterified lignin derivative, said method comprising the steps of:
providing said lignin-derived material selected from the group consisting of: lignin monomers; lignin depolymerization products; and combinations thereof;
adding a strong acid such as, sulfuric acid;
providing an amount of peroxide component in quantity sufficient to obtain up to a 1:1 mole ratio with said strong acid;
adding said peroxide component to said lignin-derived material and said strong acid to allow an oxidation reaction to take place for a pre-determined period of time sufficient to yield a composition comprising a pre-treated lignin-derived material;
wherein said pre-treated lignin-derived material comprises at least one oxidized specie;
performing an esterification reaction on said composition comprising a pre-treated lignin-derived material, said esterification reaction comprising the following steps:
   providing an acidic composition having a pH of less than 1, said acidic composition comprising:
      an acid selected from the group consisting of: sulfuric acid; an alkylsulfonic acid;
      and an arylsulfonic acid; and
      an alcohol selected from the group consisting of: C₁-C₈ linear alcohol and C₃-C₈ branched alcohol and mixtures thereof;
   combining said pre-treated lignin-derived material with said acidic composition into an esterification reaction mixture;
   heating up said esterification reaction mixture to a temperature ranging from 25° C. to 120° C.; and
   allowing sufficient time for an esterification reaction to occur to yield an esterified composition comprising said at least one esterified lignin derivative;
      wherein said esterified composition has an average molecular weight of less than 4000, as determined by gel permeation chromatography.

Preferably, the method further comprises a separation step to isolate said at least one esterified lignin derivative from the esterification reaction mixture.

According to a preferred embodiment of the present invention, the alcohol is selected from the group consisting of: methanol; ethanol; n-propanol; isopropanol; n-butanol; isobutanol; n-pentanol; neo-pentanol; isopentanol; isoamyl alcohol and mixtures thereof. Preferably, the alcohol and the strong acid are present present in a molar ratio ranging from 1.3:1 (alcohol:strong acid) to 15:1 (alcohol:strong acid). Preferably, the alcohol and the strong acid are present in a molar ratio ranging from 3:1 (alcohol:strong acid) to 5:1 (alcohol:strong acid).

According to a preferred embodiment of the present invention, the alcohol and the LHDO are present in a molar ratio ranging from 1:1 (alcohol:LHDO) to 8:1 (alcohol:LHDO). Preferably, the alcohol and the LHDO are present in a molar ratio ranging from 3:1 (alcohol:LHDO) to 5:1 (alcohol:LHDO).

According to a preferred embodiment of the present invention, the lignin-containing material results from a delignification reaction of a lignocellulosic material using a modified Caro's acid.

According to a preferred embodiment of the present invention, the said at least one esterified lignin derivative is selected from the group consisting of: alkyl malonate; alkyl maleate; alkyl succinate; alkyl oxalate; dialkyl malonate; dialkyl maleate; dialkyl succinate; dialkyl oxalate; alkyl vanillate and alkylparaben. Preferably, said at least one esterified lignin derivative is selected from the group consisting of: dibutyl malonate; dibutyl maleate; dibutyl succinate; and dibutyl oxalate; butyl vanillate and butylparaben.

Preferably, the LHDO has a strong acid content ranging from 25-50 wt., more preferably from % 40-45 wt. %.

Preferably, the strong acid is selected from the group consisting of: sulfuric acid; an alkylsulfonic acid; and an arylsulfonic acid; and combinations thereof. More preferably, the strong acid is sulfuric acid.

According to a preferred embodiment of the present invention, said lignin monomers are present in an amount ranging from 20 to 50 wt. % of said lignin-derived material

According to a preferred embodiment of the present invention, the said lignin depolymerization products are present in an amount ranging from 50 to 80 wt. % of said lignin-derived material.

According to another aspect of the present invention there is provided a method for converting a lignin-derived material into a diesel-miscible additive, said method comprising the steps of:
providing a LHDO composition comprising said lignin-derived material;
wherein said lignin-derived material comprises: lignin monomers (20 to 50 wt. % of said lignin-derived material); and lignin depolymerization products (50 to 80 wt. % of said lignin-derived material);
optionally, adding a strong acid such as, sulfuric acid to said LHDO composition;
providing an amount of peroxide component in quantity sufficient to obtain up to a 1:1 mole ratio with said strong acid;
adding said peroxide component to said lignin-derived material and said strong acid to allow a reaction to take place for a predetermined period of time sufficient to yield a pre-treated LHDO;
performing an esterification reaction on said pre-treated LHDO, said esterification reaction comprising the following steps:
   providing an acidic composition having a pH of less than 1, said acidic composition comprising:
      an acid selected from the group consisting of: sulfuric acid; an alkylsulfonic acid; and an arylsulfonic acid; and
      an alcohol selected from the group consisting of: C₁-C₈ linear alcohol and C₃-C₈ branched alcohol and mixtures thereof;
   combining said pre-treated LHDO with said acidic composition into a esterification reaction mixture;
   heating up said esterification reaction mixture to a temperature ranging from 25° C. to 120° C.; and
   allowing a reaction to convert at least some of said pre-treated LHDO into said at least one esterified lignin derivative;
wherein said at least one esterified lignin derivative has the following characteristics: low viscosity, boiling point within the range of diesel (approximately 160-350° C.), strong film-forming properties, and is miscible in a diesel fuel.

According to a preferred embodiment of the present invention, the inventors have discovered that attempts to extract some of the lignin-derived material prior to esterification led to very poor yields. The one step that is deemed of some use was to concentrate the LHDO by reducing the water content which in turn would increase the efficiency of the esterification reaction.

Preferably, the alcohol is selected from the group consisting of: methanol; ethanol; n-propanol; isopropanol; n-butanol; isobutanol and mixtures thereof. Preferably, where the alcohol and the sulfuric acid are present in a molar ratio ranging from 1.8:1 (alcohol:sulfuric acid) to 10:1 (alcohol:acid). More preferably, the alcohol and the sulfuric acid are present in a molar ratio ranging from 3:1 (alcohol:acid) to 5:1 (alcohol:acid). Even more preferably, lignin-containing material results from a delignification reaction of a lignocellulosic material using a modified Caro's acid.

According to a preferred embodiment of the present invention, said at least one esterified lignin derivative is selected from the group consisting of: dialkyl malonate; dialkyl maleate; dialkyl succinate; and dialkyl oxalate; alkyl vanillate and alkylparaben.

According to a preferred embodiment of the present invention, said at least one esterified lignin derivative is selected from the group consisting of: dibutyl malonate; dibutyl maleate; dibutyl succinate; and butylparaben.

According to a preferred embodiment of the present invention, the alkylsulfonic acid is selected from the group consisting of: methanesulfonic acid; ethanesulfonic acid; propanesulfonic acid and combinations thereof.

According to a preferred embodiment of the present invention, the arylsulfonic acid is selected from the group consisting of: toluenesulfonic acid; benzenesulfonic acid; and combinations thereof.

According to a preferred embodiment of the present invention, the feedstock which can be employed in the process include but is not limited to: raw & concentrated liquid Lignin-Hemicellulose-Depolymerization-Organics (LHDO); kraft lignin; alkali lignin; and the like.

### DETAILED DESCRIPTION OF THE PRESENT INVENTION

According to a preferred embodiment of the present invention, a lignocellulosic biomass feedstock is delignified using a modified Caro's acid. The resulting delignification yields a stream of cellulose and a stream of solubilized lignin and hemicellulose depolymerized organics (LHDO). Preferably, said lignin-hemicellulose depolymerized organics (LHDO) is a composition comprising: a strong acid and said lignin-derived material; said lignin-derived material comprises: lignin monomers (20 to 50 wt. %); lignin depolymerization products (50 to 80 wt. %). The terms lignin depolymerization products or material may be used interchangeably herein with the term lignin oligomers, in either instance they are meant to distinguish lignin-derived material which are not considered to be lignin monomers.

According to a preferred embodiment of the present invention, the LHDO obtained from a delignification reaction of lignocellulosic biomass using a modified Caro's acid, comprises what can be considered as a bi-modal lignin-derived product distribution. There is a large concentration of compounds in the C₃-C₁₀ range, referred to as the light fraction, and another large concentration of compounds in the C₁₂-C₃₀ range, referred to as the heavy fraction. Preferably, esterification reactions react with the carboxylic acid groups and thus make them less hydrophilic, allowing them to be separated from an aqueous environment and isolated. Peroxide pre-treatment reactions are also aimed at converting larger compounds (such as lignin oligomers) into smaller ones (such as lignin monomers) to increase the yield of various esters of lignin monomers and other low-molecular weight esters such as those found in the light fraction.

Preferably, to achieve such streams, the biomass comprising lignin, hemicellulose and cellulose fibers may be mechanically treated to reduce particle size prior to contacting it to a modified Caro's acid.

According to preferred embodiment of the present invention, the modified Caro's acid (as disclosed in Canadian patent application 3,128,678) comprises: sulfuric acid; a heterocyclic compound; and wherein sulfuric acid and said a heterocyclic compound; are present in a molar ratio of no less than 1:1. Preferably, the sulfuric acid and said heterocyclic compound are present in a molar ratio ranging from 28:1 to 2:1. More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. Preferably, the sulfuric acid and heterocyclic compound are present in a molar ratio ranging from 12:1 to 6:1. Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to preferred embodiment of the present invention, the modified Caro's acid (as disclosed in Canadian patent application 3,128,677) comprises: sulfuric acid; a modifying agent comprising a compound containing an amine group; and wherein sulfuric acid and said compound containing an amine group; are present in a molar ratio of no less than 1:1. Preferably, the sulfuric acid and said compound containing an amine group are present in a molar ratio ranging from 28:1 to 2:1. More preferably, the sulfuric acid and compound containing an amine group are present in a molar ratio ranging from 24:1 to 3:1. Preferably, the sulfuric acid and compound containing an amine group are present in a molar ratio ranging from 20:1 to 4:1. More preferably, the sulfuric acid and compound containing an amine group are present in a molar ratio ranging from 16:1 to 5:1. Preferably, the sulfuric acid and compound containing an amine group are present in a molar ratio ranging from 12:1 to 6:1. According to a preferred embodiment of the present invention, the modifying agent is selected in the group consisting of: TEOA; MEOA; pyrrolidine; DEOA; ethylenediamine; diethylamine; triethylamine; morpholine; MEA-triazine; and combinations thereof. According to a more preferred embodiment of the present invention, the modifying agent is TEOA; MEOA; pyrrolidine; DEOA; ethylenediamine; triethylamine.

According to preferred embodiment of the present invention, the modified Caro's acid (as disclosed in Canadian patent application 3,128,676) comprises: sulfuric acid; a modifying agent comprising an alkanesulfonic acid; and wherein sulfuric acid and said alkanesulfonic acid are present in a molar ratio of no less than 1:1. Preferably, said alkanesulfonic acid is selected from the group consisting of: alkanesulfonic acids where the alkyl groups range from C₁-C₆ and are linear or branched; and combinations thereof. Preferably, said alkanesulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkanesulfonic acid is methanesulfonic acid. Also preferably, said alkanesulfonic acid has a molecular weight below 300 g/mol. Also preferably, said alkanesulfonic acid has a molecular weight below 150 g/mol. Preferably, the sulfuric acid and said alkanesulfonic acid and are present in a molar ratio ranging from 28:1 to 2:1. More preferably, the sulfuric acid and alkanesulfonic acid are present in a molar ratio ranging from 24:1 to 3:1. Preferably, the sulfuric acid and alkanesulfonic acid are present in a molar ratio ranging from 20:1 to 4:1. More preferably, the sulfuric acid and alkanesulfonic acid are present in a molar ratio ranging from 16:1 to 5:1. According to a preferred embodiment of the present invention, the sulfuric acid and alkanesulfonic acid are present in a molar ratio ranging from 12:1 to 6:1.

According to preferred embodiment of the present invention, the modified Caro's acid (as disclosed in Canadian patent application 3,128,675) comprises: sulfuric acid; a substituted aromatic compound; and wherein sulfuric acid and said substituted aromatic compound; are present in a molar ratio of no less than 1:1. Preferably, the substituted aromatic compound comprises at least two substituents. More preferably, at least one substituent is an amine group and at least one of the other substituent is a sulfonic acid moiety. According to a preferred embodiment, the substituted aromatic compound comprises three or more substituent. According to a preferred embodiment of the present invention, the substituted aromatic compound comprises at least a sulfonic acid moiety. According to another preferred embodiment of the present invention, the substituted aromatic compound comprises an aromatic compound having a sulfonamide substituent, where the compound can be selected from the group consisting of: benzenesulfonamides; toluenesulfonamides; substituted benzenesulfonamides; and substituted toluenesulfonamides. Preferably, the sulfuric acid and said substituted aromatic compound and are present in a molar ratio ranging from 28:1 to 2:1. More preferably, the sulfuric acid and substituted aromatic compound are present in a molar ratio ranging from 24:1 to 3:1. Preferably, the sulfuric acid and substituted aromatic compound are present in a molar ratio ranging from 20:1 to 4:1. More preferably, the sulfuric acid and substituted aromatic compound are present in a molar ratio ranging from 16:1 to 5:1. Preferably, the sulfuric acid and substituted aromatic compound are present in a molar ratio ranging from 12:1 to 6:1.

According to preferred embodiment of the present invention, the modified Caro's acid (as disclosed in Canadian patent application 3,128,674) comprises: sulfuric acid; a modifying agent comprising an arylsulfonic acid; and optionally, a compound containing an amine group; wherein sulfuric acid and said a arylsulfonic acid; are present in a molar ratio of no less than 1:1. Preferably, the compound containing an amine group is selected from the group consisting of: imidazole; N-methylimidazole; triazole; monoethanolamine (MEOA); diethanolamine (DEOA); triethanolamine (TEOA); pyrrolidine and combinations thereof. According to a preferred embodiment of the present invention, sulfuric acid and the peroxide are present in a molar ratio of approximately 1:1. Preferably, the sulfuric acid and said arylsulfonic acid and are present in a molar ratio ranging from 28:1 to 2:1. More preferably, the sulfuric acid and arylsulfonic acid are present in a molar ratio ranging from 24:1 to 3:1. Preferably, the sulfuric acid and arylsulfonic acid are present in a molar ratio ranging from 20:1 to 4:1. More preferably, the sulfuric acid and arylsulfonic acid are present in a molar ratio ranging from 16:1 to 5:1. According to a preferred embodiment of the present invention, the sulfuric acid and arylsulfonic acid are present in a molar ratio ranging from 12:1 to 6:1. Also preferably, said arylsulfonic acid has a molecular weight below 300 g/mol. Also preferably, said arylsulfonic acid has a molecular weight below 150 g/mol. Even more preferably, said arylsulfonic acid is selected from the group consisting of: orthanilic acid; metanilic acid; sulfanilic acid; toluenesulfonic acid; benzenesulfonic acid; and combinations thereof.

According to preferred embodiment of the present invention, the modified Caro's acid (as disclosed in Canadian patent application 3,128,673) comprises: sulfuric acid; a heterocyclic compound; an alkanesulfonic acid; and wherein sulfuric acid and said a heterocyclic compound; are present in a molar ratio of no less than 1:1. Preferably, said aqueous acidic composition comprising: sulfuric acid; a heterocyclic compound; an arylsulfonic acid; and wherein sulfuric acid and said a heterocyclic compound; are present in a molar ratio of no less than 1:1. Preferably, the arylsulfonic acid is toluenesulfonic acid.

Preferably, the sulfuric acid, the heterocyclic compound and the alkanesulfonic acid are present in a molar ratio ranging from 28:1:1 to 2:1:1. More preferably, the sulfuric acid the heterocyclic compound and the alkanesulfonic acid are present in a molar ratio ranging from 24:1:1 to 3:1:1. Preferably, the sulfuric acid, the heterocyclic compound and the alkanesulfonic acid are present in a molar ratio ranging from 20:1:1 to 4:1:1. More preferably, the sulfuric acid, the heterocyclic compound and the alkanesulfonic acid are present in a molar ratio ranging from 16:1:1 to 5:1:1. According to a preferred embodiment of the present invention, the sulfuric acid and heterocyclic compound are present in a molar ratio ranging from 12:1:1 to 6:1:1. Also preferably, said heterocyclic compound has a molecular weight below 300 g/mol. Also preferably, said heterocyclic compound has a molecular weight below 150 g/mol. Even more preferably, said heterocyclic compound is selected from the group consisting of: imidazole; triazole; n-methylimidazole; and combinations thereof. Preferably, the alkanesulfonic acid is selected from the group consisting of:
alkylsulfonic acids where the alkyl groups range from C₁-C₆ and are linear or branched; and combinations thereof. Preferably, said alkylsulfonic acid is selected from the group consisting of:
methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkylsulfonic acid is methanesulfonic acid.

According to preferred embodiment of the present invention, the modified Caro's acid (as disclosed in Canadian patent application 3,128,672) comprises: sulfuric acid; a carbonyl-containing nitrogenous base compound; and wherein sulfuric acid and said a carbonyl-containing nitrogenous base compound; are present in a molar ratio of no less than 1:1. According to a preferred embodiment of the present invention, the carbonyl-containing nitrogenous base compound is selected from the group consisting of: caffeine; lysine; creatine; glutamine; creatinine; 4-aminobenzoic acid; glycine; NMP (N-methyl-2-pyrrolidinone); histidine; DMA (N,N-dimethylacetamide); arginine; 2,3-pyridinedicarboxylic acid; hydantoin; and combinations thereof. Preferably, the sulfuric acid and said carbonyl-containing nitrogenous base compound and are present in a molar ratio ranging from 28:1 to 2:1. More preferably, the sulfuric acid and carbonyl-containing nitrogenous base compound are present in a molar ratio ranging from 24:1 to 3:1. Preferably, the sulfuric acid and carbonyl-containing nitrogenous base compound are present in a molar ratio ranging from 20:1 to 4:1. More preferably, the sulfuric acid and carbonyl-containing nitrogenous base compound are present in a molar ratio ranging from 16:1 to 5:1. According to a preferred embodiment of the present invention, the sulfuric acid and carbonyl-containing nitrogenous base compound are present in a molar ratio ranging from 12:1 to 6:1.

According to a preferred embodiment of the present invention, said lignocellulosic biomass comprising lignin, hemicellulose and cellulose is exposed to a modified Caro's acid composition having a pH of less than 1, said modified Caro's acid composition selected from the group consisting of composition A; composition B; composition C; composition D; composition E; composition F; composition G; composition H; composition I; and composition J;
wherein said composition A comprises:
   sulfuric acid;
   a compound comprising an amine moiety and a sulfonic acid moiety; and
   a peroxide; and wherein sulfuric acid, said compound comprising an amine moiety and a sulfonic acid moiety and said peroxide are present in a molar ratio of no less than 1:1:1;
wherein said composition B comprises:
   sulfuric acid;
   a compound comprising an amine moiety;
   a compound comprising a sulfonic acid moiety; and
   a peroxide; wherein sulfuric acid and said a compound comprising an amine moiety and said compound comprising a sulfonic acid moiety are present in a molar ratio of no less than 1:1:1;
wherein said composition C comprises:
   an alkylsulfonic acid; and
   a peroxide; wherein said alkylsulfonic acid and said peroxide are present in a molar ratio of no less than 1:1;
wherein said composition D comprises:
   sulfuric acid;
   a heterocyclic compound; and
   a peroxide; and wherein sulfuric acid and said a heterocyclic compound; are present in a molar ratio of no less than 1:1;
wherein said composition E comprises:
   sulfuric acid;
   a modifying agent comprising a compound containing an amine group; and
   a peroxide; and wherein sulfuric acid and said compound containing an amine group; are present in a molar ratio of no less than 1:1;
wherein said composition F comprises:
   sulfuric acid;
   a modifying agent comprising an alkanesulfonic acid and
   a peroxide; and wherein sulfuric acid and said alkanesulfonic acid are present in a molar ratio of no less than 1:1;
wherein said composition G comprises:
   sulfuric acid;
   a substituted aromatic compound; and
   a peroxide; and wherein sulfuric acid and said substituted aromatic compound; are present in a molar ratio of no less than 1:1;
wherein said composition H comprises:
   sulfuric acid;
   a modifying agent comprising an arylsulfonic acid;
   a peroxide; and
   optionally, a compound containing an amine group; wherein sulfuric acid and said arylsulfonic acid are present in a molar ratio of no less than 1:1;
wherein said composition I comprises:
   sulfuric acid;
   a heterocyclic compound;
   an alkanesulfonic acid; and
   a peroxide; and wherein sulfuric acid and said a heterocyclic compound; are present in a molar ratio of no less than 1:1;
wherein said composition J comprises:
   sulfuric acid;
   a carbonyl-containing nitrogenous base compound; and
   a peroxide; and wherein sulfuric acid and said a carbonyl-containing nitrogenous base compound; are present in a molar ratio of no less than 1:1.

According to a preferred embodiment of the present invention, the lignocellulosic biomass mixture comprising hemicellulose, lignin, and cellulose is exposed to a modified Caro's acid composition at a temperature and for a period of time sufficient to a delignification reaction to occur and remove over 98.5% wt. of said lignin and over 70% wt. of the hemicellulose in a liquid stream preferably leaving in solid form most of the cellulose from said biomass.

Preferably, said compound comprising an amine moiety and a sulfonic acid moiety is selected from the group consisting of taurine; taurine derivatives; and taurine-related compounds.

Preferably, exposing said biomass to said modified Caro's acid composition will allow the delignification reaction to occur and remove over 90 wt % of said lignin and hemicellulose from said biomass. Preferably, the delignification reaction is carried out at a temperature below 55° C. by a method selected from the group consisting of:
adding water into said vessel;
adding biomass into said vessel; and
using a heat exchanger.

Preferably, said sulfuric acid, said compound comprising an amine moiety and a sulfonic acid moiety and said peroxide are present in a molar ratio of no less than 1:1:1. Also preferably, said sulfuric acid, said compound comprising an amine moiety and a sulfonic acid moiety and said peroxide are present in a molar ratio of no more than 15:1:1. Preferably, said sulfuric acid and said compound comprising an amine moiety and a sulfonic acid moiety are present in a molar ratio of no less than 3:1.

Preferably, said modifier compound comprising an amine moiety and a sulfonic acid moiety is selected from the group consisting of: taurine; taurine derivatives; and taurine-related compounds. Preferablty, said taurine derivative or taurine-related compound is selected from the group consisting of: taurolidine; taurocholic acid; tauroselcholic acid; tauromustine; 5-taurinomethyluridine and 5-taurinomethyl-2-thiouridine; homotaurine (tramiprosate); acamprosate; and taurates; as well as aminoalkylsulfonic acids where the alkyl is selected from the group consisting of C₁-C₈ linear alkyl and C₁-C₅ branched alkyl. Preferably, said linear alkylaminosulfonic acid is selected form the group consisting of: methyl; ethyl (taurine); propyl; and butyl. Preferably, said branched aminoalkylsulfonic acid is selected from the group consisting of: isopropyl; isobutyl; and isopentyl.

Preferably, said sulfuric acid and compound comprising an amine moiety and a sulfonic acid moiety are present in a molar ratio of no less than 3:1.

Preferably, said compound comprising an amine moiety is an alkanolamine is selected from the group consisting of: monoethanolamine; diethanolamine; triethanolamine; and combinations thereof.

Preferably, said compound comprising a sulfonic acid moiety is selected from the group consisting of: alkylsulfonic acids and combinations thereof. More preferably, said alkylsulfonic acid is selected from the group consisting of: alkylsulfonic acids where the alkyl groups range from C₁-C₆ and are linear or branched; and combinations thereof. Yet even more preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof.

Also preferably, said alkylsulfonic acid; and said peroxide are present in a molar ratio of no less than 1:1. Preferably, said compound comprising a sulfonic acid moiety is methanesulfonic acid.

Preferably, in Composition C, said sulfuric acid and said a compound comprising an amine moiety and said compound comprising a sulfonic acid moiety are present in a molar ratio of no less than 1:1:1. More preferably, in Composition C, said sulfuric acid, said compound comprising an amine moiety and said compound comprising a sulfonic acid moiety are present in a molar ratio ranging from 28:1:1 to 2:1:1.

According to a preferred embodiment of the present invention, the alcohol is selected from the group consisting of: C₁-C₈ linear alcohols and C₃-C₈ branched alcohols and mixtures thereof. Preferably, the alcohol is selected from the group consisting of: isoamyl alcohol, 2-butanol, isobutyl alcohol, 2-ethylhexanol, 2-octanol; methanol, ethanol, n-propanol, isopropanol, n-butanol, n-hexanol, n-octanol. More preferably, the alcohol is selected from the group consisting of: methanol, ethanol, n-propanol, isopropanol, n-butanol, n-hexanol, n-octanol and combinations thereof.

According to a preferred embodiment of the present invention, the ratio of alcohol:feedstock is present in a weight ratio ranges from 0.5:1 to 8:1. More preferably, the alcohol:feedstock weight ratio ranges from 1:1 to 6:1. Even more preferably, the alcohol:feedstock weight ratio ranges from 2:1 to 4:1. According to a preferred embodiment of the present invention, the ratio of alcohol:feedstock is present in a weight ratio of 3:1.

According to a preferred embodiment of the present invention, the duration of the reaction is up to 3 hours. According to another preferred embodiment of the present invention, the duration of the reaction is up to 6 hours. According to yet another preferred embodiment of the present invention, the duration of the reaction is up to 18 hours. According to yet another preferred embodiment of the present invention, the duration of the reaction is up to 24 hours.

According to a preferred embodiment of the present invention, the reaction is carried out at a temperature of 25° C. According to another preferred embodiment of the present invention, the reaction is carried out at a temperature of up to 40° C. According to another preferred embodiment of the present invention, the reaction is carried out at a temperature of up to 60° C. According to another preferred embodiment of the present invention, the reaction is carried out at a temperature of up to 80° C. According to another preferred embodiment of the present invention, the reaction is carried out at a temperature of up to 100° C. According to another preferred embodiment of the present invention, the reaction is carried out at a temperature of up to 120° C.

General Procedure for Esterification Reactions with a Peroxide Pre-Treatment

Raw LHDO feedstock was rotavapped to remove as much water as possible, and then the residue was titrated to measure acid content. Then the required amount of hydrogen peroxide was added to obtain a 1:1 molar ratio of sulfuric acid:peroxide. This mixture was also stirred for between 3-72 hours at either 25 or 50° C., and then an esterification reaction was performed.

In this preferred embodiment, the aim was to further fragment the remaining lignin-derived material (organic compounds) found in the LHDO stream and increase the amount of small molecules in the esterified LHDO.

After isolation of the oil, hexanes were added, which dissolved the most hydrophobic portion of the LHDO, leaving behind the less hydrophobic portion. Previously, when this procedure was carried out on the unmodified esterified LHDO, the hexanes were able to dissolve all of the small molecules (the diester compounds and aromatic monomers) along with the low-molecular weight esters. When carried out after performing the oxidation pre-treatment on the finished oil, it was found that the product contained less hexane-soluble material than the unmodified LHDO. While it may seem counterintuitive at first glance, it is believed that this oxidation step (with the peroxide) did break down many of the compounds in the LHDO to some extent, as well as increased the oxygen content of the material, making the resulting compounds in the mixture more polar and therefore less hexane-soluble.

### Experiment #1

50-100 g of raw LHDO was added to a round-bottom flask, and the mixture was rotavapped to remove as much water as possible, and then the residue was weighed and then titrated to determine the concentration of sulfuric acid.

Hydrogen peroxide was then added to obtain a 1:1 molar ratio of sulfuric acid:hydrogen peroxide, and then the flask was placed in an oil bath on a heating stir plate, and the oil bath temperature was set to either 25 or 50° C. The mixture was then left to stir for 24 hours. Preferably, the period of time for the pre-treatment is pre-determined and is expected to coincide, in most cases, with a colour change. A lightening of the solution may be observed, which is indicative of a decrease in average molecular weight (i.e. breaking up of conjugated systems). In many cases, this has been determined to be roughly 24 hours. This can be confirmed by assessing peroxide consumption by titration. Preferably, at least 10% of the peroxide will have been consumed. After completion of the first step, said pre-treated lignin-derived material comprises at least one oxidized chemical specie.

After 24 hours, the required amount of butanol was added to the mixture to obtain a 1:1 weight ratio of butanol:LHDO, and then an air condenser was attached and the mixture was heated to 55° C. and stirred for 18 hours.

The flask was cooled, and the mixture was filtered through a fritted filter to remove precipitated taurine. The taurine (remaining as a modifier used a modified Caro's acid from the delignification reaction) was rinsed with additional butanol, collected, and dried in an oven overnight at 50° C. The filtrate was collected and transferred to a roundbottom flask, and then the butanol was removed on a rotavap. The residue was transferred to a separatory funnel and ethyl acetate and water were added. The mixture was shaken vigorously and then left to separate. The ethyl acetate phase was collected, and the aqueous phase was extracted a second time with fresh ethyl acetate. The ethyl acetate phases were combined and then poured back into a separatory funnel, and pH 3.5 sulfate buffer solution was added. The mixture was shaken vigorously and then left to separate. The ethyl acetate layer was collected, dried with magnesium sulfate, filtered, and then rotavapped to remove the ethyl acetate, yielding esterified LHDO as an oil.

The oil was characterized by NMR, acid-base titrations and Karl-Fischer titrations to determine water content. The remaining oil was mixed with an equal mass of hexanes and shaken vigorously, then left to separate. The hexanes solution was removed, fresh hexanes added, and the process repeated. The hexanes solutions were combined, rotavapped and weighed to determine the percentage of hydrophobic material present in the oil. The hexanes-insoluble portion was then rotavapped as well to remove any residual solvent, and then analyzed by gel permeation chromatography to measure the molecular weight distribution of the material.

Total Acid Number (TAN) gives an indication of the efficiency of the reaction. The definition of TAN is the mass in mg of KOH required to neutralize 1 g of oil, which means that the more acid the oil contains, the higher the TAN value will be. The starting LHDO contains a of lot of carboxylic acid compounds and would therefore have a very high TAN value (above 500). As these acids get converted into esters, they no longer react with KOH and so the TAN value will decrease, and so the more acid groups that get converted into esters, the lower the TAN value of the finished product will be. Lower TAN value means fewer carboxylic acids in the finished product which, in turn, means greater conversion efficiency. Yield values: above 60% is excellent, 50-60% is good, 30-50% is moderate, below 30% is poor. Water content values: above 1.5% is poor, between 0.5-1.5% is moderate, between 0.5-0.2% is good, below 0.2% is excellent. TAN values: above 150 is poor, between 100-150 is moderate, between 50-100 is good (matches pyrolysis oil), below 50 is excellent.

TABLE 1
Yields of experiments carried out according to a preferred embodiment
of the present invention at 55° C. for a period of 18 hours

| | | Esterification | | | | | Hexane- |
|---|---|---|---|---|---|---|---|
| Pretreatment | Pretreatment | BuOH:LHDO | | | | | soluble |
| Time | temp | ratio | % Yield | % H₂O | SAN | TAN | Fraction |
| N/A | N/A | 1:1 | 63.40 | 0.03 | 13.77 | 23.72 | 43.8% |
| 24 h | 25 C. | 1:1 | 51.53 | 0.05 | 32.18 | 44.76 | 29.5% |
| 24 h | 50 C. | 1:1 | 31.43 | 0.22 | 32.54 | 72.02 | 26.8% |

The data summarized in table 1 indicates that esterification on the LHDO which had been exposed to a peroxide pre-treatment the composition yielded a lower percentage of hexane soluble compounds than the composition which had not had a pre-treatment step.

Also noted, the SAN values increased over the control value. SAN refers to the strong acid number obtained when a titration is carried out which endpoint is at pH 4 (this applies mostly to mineral acids, but there are some carboxylic acids which are strong enough to be titrated at this pH). The estimated molecular weight of the compounds generated by both the peroxide pre-treated LHDO (at 50° C.) and the non-pre-treated LHDO showed that the pre-treated composition had a roughly 10% decrease in mol. wt. versus the non-treated composition. This provides support that a peroxide pre-treatment of a LHDO composition can increase the yield of small molecules. Small molecules obtained from such oxidative degradation are generally value-added products which may be used in a number of different settings. The decrease in average molecular weight is also an indication that the process according to a preferred embodiment of the present invention, may be used to convert a heavy fraction lignin derivative to a lighter fraction lignin derivative and consequently be used as a diesel fuel additive or blend component. In some instances, the esterified component is ideally suited to be an additive for a diesel due to its hydrophobicity, low viscosity, boiling point within the range of diesel (approximately 160-350° C.), film-forming properties, and other benefits.

TABLE 2
Yields of experiments carried out according to a preferred embodiment
of the present invention with a pretreatment time of 24 hours
at 50° C. followed by esterification using a 1:1 BuOH:LHDO
ratio and carried out at 55° C. for a period of 18 hours

| Pre-treatment | | | | | Hexane- |
|---|---|---|---|---|---|
| H₂SO₄:H₂O₂ | % | % | | | soluble |
| ratio | Yield | H₂O | SAN | TAN | Fraction |
| 10:1 | 51.68% | 0.02 | 16.01 | 28.83 | 51.78 |
| 7:1 | 47.69% | 0.15 | 18.84 | 32.8 | 61.78 |
| 5:1 | 43.89% | 0.10 | 16.99 | 27.53 | 57.98 |
| 3:1 | 37.16% | 0.16 | 22.59 | 47 | 55.73 |
| 1:2 | 8.93% | N/A | N/A | N/A | 8.83 |
| n/a (control) | 60.75% | 0.01 | 17.03 | 32.32 | 50.51 |

The data reported in Table 2 shows the impact of the H₂SO₄:H₂O₂ ratio on the final product yield. As can be seen, the higher the acid to peroxide ratio the higher the percentage of hexane-soluble material. The percentage of hexane-soluble material slowly decreased with a decreasing acid to peroxide ratio until the peroxide was in excess, as shown in the 1:2 acid:peroxide example. In this case, both the isolated yield and hexane-soluble fraction were extremely low. This indicates an over-oxidation of the LHDO into mostly non-esterifiable products, and the products that could be esterified were highly oxidized and more hydrophilic, minimizing the amount of hexane-soluble material. The hexane-soluble fraction can be used as an indication of the percentage of the mixture which can be used in diesel-related applications. An increase in such fraction is desirable. Table 2 also indicates that there is a preferable ratio of acid to peroxide where insufficient peroxide leads to low hexane soluble fraction and excess peroxide leads to over-oxidation and consequently very low yields in the hexane-soluble fraction as the molecules tend to be more hydrophilic.

As a point of note, the compositions used in the control experiments, were by and large depleted of water prior to the esterification reaction. As is well known, the presence of water inhibits esterification reactions. In the case of the pre-treated compositions, the presence of peroxide also means the presence of water, which when carried over to the esterification step, ultimately acted as some sort of inhibitor to the esterification reaction. Hence, the yields obtained are affected by this factor but when taken as a whole, the combined reaction of pre-treatment with an oxidizing composition followed by an esterification reaction, provides for a substantial advancement in the method of separating heavy and light fractions found in the LHDO as well as a method to generate small value added chemicals derived from the lignin remaining from delignification of plant biomass.

TABLE 3
Yields of experiments carried out according to a preferred embodiment
of the present invention with a varying pretreatment time at
50° C. followed by esterification using a 1:1 BuOH:LHDO
ratio and carried out at 55° C. for a period of 18 hours

| Pre- | Pre-treatment | | | | | Hexane- |
|---|---|---|---|---|---|---|
| treatment | H₂SO₄:H₂O₂ | | | | | soluble |
| time (h) | ratio | % Yield | % H₂O | SAN | TAN | Fraction |
| 3 | 1:1 | 44.25% | 0.1 | 40.58 | 52.56 | 53.1 |
| 6 | 1:1 | 46.11% | 0.51 | 50.48 | 66.16 | 52.2 |
| 18 | 1:1 | 39.12% | 0.275 | 29.38 | 48.24 | 52.19 |
| | n/a (control) | 60.75% | 0.01 | 17.03 | 32.32 | 50.51 |

Table 3 indicates that there is negligible difference between a 3- and 6-hour pretreatment at 55 C, but after an 18-hour pre-treatment the recovered yield from the subsequent esterification was lower. This suggests that over-oxidation may have occurred to produce non-esterifiable products which would be lost in the subsequent esterification step.

TABLE 4
Yields of experiments carried out according to a preferred embodiment
of the present invention with a pretreatment time of 24 hours
at 25° C. followed by esterification using a 1:1 BuOH:LHDO
ratio and carried out at 55° C. for a period of 18 hours

| Pre-treatment | | | | | Hexane- |
|---|---|---|---|---|---|
| H₂SO₄:H₂O₂ | % | % | | | soluble |
| ratio | Yield | H₂O | SAN | TAN | Fraction |
| 7:1 | 52.06% | 0.06 | 22.59 | 28.76 | 58.82 |
| 5:1 | 52.77% | 0.065 | 20.86 | 35.34 | 63.54 |
| 3:1 | 53.12% | 0.08 | 22.12 | 35.41 | 62.82 |
| n/a (control) | 60.75% | 0.01 | 17.03 | 32.32 | 50.51 |

The results in Table 4 show the reverse trend of those in Table 2 where the percentage of hexane-soluble material in the esterified product decreased with decreasing acid to peroxide ratio. In this case, when the pretreatment was carried out at 25° C., the percentage of hexane-soluble material in the esterified product increased with decreasing acid to peroxide ratio. This indicates that at lower temperatures the oxidative pretreatment is sluggish and requires higher peroxide concentrations to drive the reaction forward and generate more low-molecular weight compounds which are then converted into hexane-soluble products in the subsequent esterification reaction.

### Increased Peroxide Degradation Rates at Elevated Temperatures

Under acidic conditions such as those found in raw LHDO solution obtained by a delignification as described hereinabove, hydrogen peroxide is prone to more accelerated decomposition. At elevated temperatures, this process occurs even more rapidly, to the extent that at temperatures greater than 70° C. the majority of the hydrogen peroxide will decompose before reacting with the LHDO, dramatically decreasing its effectiveness for the desired oxidative fragmentation reactions of the lignin material. Therefore, to ensure an effective oxidative pretreatment reaction, temperatures are kept to 50° C. or less to reduce unwanted decomposition and favour oxidative fragmentation of the LHDO.

### Effect of Variation of Sulfuric Acid:Peroxide Ratio on Oxidative Pretreatment

When carrying out an oxidative pretreatment on LHDO prior to esterification, the ratio of sulfuric acid to hydrogen peroxide plays a large role in determining both the amount and types of LHDO species produced. The primary goal of the oxidative pretreatment is to increase the amount of hydrophobic, low-molecular weight species present in the final esterified product, as these compounds are commercially valuable materials. Initially, the hydrogen peroxide will promote fragmentation reactions, decreasing the molecular weight of the heavy fraction and producing more light fraction species. If additional peroxide is present, however, it can continue to react with these new light fraction species and produce over-oxidation products which are now hydrophilic and no longer commercially valuable. Therefore, there needs to be enough hydrogen peroxide present in the pretreatment mixture to trigger the fragmentation reactions, but not too much to cause over-oxidation. The data presented herein shows that between the acid:peroxide ratio ranges of 7:1-1:1 there are slight decreases in recovered yield and in the hexane-soluble fraction, which is an indication of the concentration of hydrophobic molecules present in the product. However, when the ratio flips to an excess of peroxide over the acid, as shown in the 1:2 ratio (acid:peroxide) reaction, over-oxidation of the LHDO occurs, resulting in major decreases in both yield and hexane-soluble material.

Examples of hexane-soluble material include but are not limited to, dibutyl malonate, dibutyl maleate, dibutyl succinate, butylparaben, and similar low-molecular weight aromatic esters.

It follows that the method according to a preferred embodiment of the present invention, generates a higher yield of hexane-soluble material than in the control experiment, i.e. when there is no oxidative pre-treatment. This is important to note, as it is desirable to generate more small, value-added products, especially given the fact that the remaining esterified material is mainly intended on being used a fuel (for various purposes depending on their molecular weights).

### Aging of LHDO

The LHDO produced from the delignification of biomass is a blend of low-molecular weight and high-molecular weight species, referred to as the light and heavy fractions, respectively. This mixture comes out of the delignification reaction as an aqueous solution containing 25-50 wt % sulfuric acid. Over time, this acid catalyzes condensation reactions between the various lignin fragments, increasing the molecular weight of the heavy fraction and consuming portions of the light fraction. This process can be visually observed by a darkening of the LHDO from a bright orange to a dark brown. At ambient temperatures this process occurs relatively slowly, over the course of weeks to months, but at elevated temperatures it proceeds much more rapidly and the colour change can be observed within days. Therefore, when carrying out chemical treatments to alter the molecular weight distribution of the LHDO, either deliberately accelerating the acid condensation reactions to increase molecular weight or adding an oxidant to fragment the molecules and decrease the average molecular weight, it is important to determine the starting molecular weight distribution as close as possible to the time of the chemical treatments to establish an accurate baseline and determine the effectiveness of the treatment. Preferably, it is highly desirable to use ‘fresh’ LHDO when carrying out further chemical modifications on it. Fresh LHDO should be understood by the person skilled in the art being knowledgeable about the condensation of molecules contained in said delignified LHDO compositions, as being no older than a few weeks (again, depending on the storage conditions to which said LHDO has been exposed).

When used in this specification and claims, the terms “comprises” and “comprising” and variations thereof mean that the specified features, steps or integers are included. The terms are not to be interpreted to exclude the presence of other features, steps or components. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A method for converting a LHDO composition comprising a lignin-derived material into at least one esterified lignin derivative, said method comprising the steps of
providing said lignin-derived material selected from the group consisting of lignin monomers; lignin depolymerization products; and combinations thereof;
adding a strong acid such as, sulfuric acid;
providing an amount of peroxide component in quantity sufficient to obtain up to a 1:1 mole ratio with said strong acid;
adding said peroxide component to said lignin-derived material and said strong acid to allow an oxidation reaction to take place for a pre-determined period of time sufficient to yield a composition comprising a pre-treated lignin-derived material;
wherein said pre-treated lignin-derived material comprises at least one oxidized specie;
performing an esterification reaction on said composition comprising a pre-treated lignin-derived material, said esterification reaction comprising the following steps:
providing an acidic composition having a pH of less than 1, said acidic composition comprising:
an acid selected from the group consisting of sulfuric acid; an alkylsulfonic acid; and an arylsulfonic acid; and
an alcohol selected from the group consisting of C₁-C₈ linear alcohol and C₃-C₈ branched alcohol and mixtures thereof;
combining said pre-treated lignin-derived material with said acidic composition into an esterification reaction mixture;
heating up said esterification reaction mixture to a temperature ranging from 25° C. to 120° C.; and
allowing sufficient time for an esterification reaction to occur to yield an esterified composition comprising said at least one esterified lignin derivative;
wherein said esterified composition has an average molecular weight of less than 4000, as determined by gel permeation chromatography.

2. The method according to claim 1 further comprising a separation step to isolate said at least one esterified lignin derivative from the esterification reaction mixture.

3. The method according to claim 1, wherein the alcohol is selected from the group consisting of: methanol; ethanol; n-propanol; isopropanol; n-butanol; isobutanol; n-pentanol; neo-pentanol; isopentanol; isoamyl alcohol and mixtures thereof.

4. The method according to claim 1, wherein the alcohol and the strong acid are present in a molar ratio ranging from 1.3:1 (alcohol:strong acid) to 15:1 (alcohol:strong acid).

5. The method according to claim 1, wherein the alcohol and the strong acid are present in a molar ratio ranging from 3:1 (alcohol:strong acid) to 5:1 (alcohol:strong acid).

6. The method according to claim 1, wherein the alcohol and the LHDO are present in a molar ratio ranging from 1:1 (alcohol:LHDO) to 8:1 (alcohol:LHDO).

7. The method according to claim 1, wherein the alcohol and the LHDO are present in a molar ratio ranging from 3:1 (alcohol:LHDO) to 5:1 (alcohol:LHDO).

8. The method according to claim 1, wherein the lignin-containing material results from a delignification reaction of a lignocellulosic material using a modified Caro's acid.

9. The method according to claim 1, wherein said at least one esterified lignin derivative is selected from the group consisting of: alkyl malonate; alkyl maleate; alkyl succinate; alkyl oxalate; dialkyl malonate; dialkyl maleate; dialkyl succinate; dialkyl oxalate; alkyl vanillate and alkylparaben.

10. The method according to claim 9, wherein said at least one esterified lignin derivative is selected from the group consisting of: dibutyl malonate; dibutyl maleate; dibutyl succinate; and dibutyl oxalate; butyl vanillate and butylparaben.

11. The method according to claim 1, wherein the LHDO has a strong acid content ranging from 25-50 wt. %.

12. The method according to claim 1, wherein the LHDO has a strong acid content ranging from 40-45 wt. %.

13. The method according to claim 1, wherein the strong acid is selected from the group consisting of: sulfuric acid; an alkylsulfonic acid; and an arylsulfonic acid; and combinations thereof.

14. The method according to claim 12, wherein the strong acid is sulfuric acid.

15. The method according to claim 1, wherein said lignin monomers are present in an amount ranging from 20 to 50 wt. % of said lignin-derived material

16. The method according to claim 1, wherein said lignin depolymerization products are present in an amount ranging from 50 to 80 wt. % of said lignin-derived material.

17. A method for converting a lignin-derived material into a diesel-miscible additive, said method comprising the steps of:
providing said lignin-derived material selected from the group consisting of: lignin monomers; lignin depolymerization products; and combinations thereof;
adding a strong acid such as, sulfuric acid;
providing an amount of peroxide component in quantity sufficient to obtain up to a 1:1 mole ratio with said strong acid;
adding said peroxide component to said lignin-derived material and said strong acid to allow an oxidation reaction to take place for a pre-determined period of time sufficient to yield a composition comprising a pre-treated lignin-derived material;
wherein said pre-treated lignin-derived material comprises at least one oxidized specie; and
performing an esterification reaction on said composition comprising a pre-treated lignin-derived material, said esterification reaction comprising the following steps:
providing an acidic composition having a pH of less than 1, said acidic composition comprising:
an acid selected from the group consisting of: sulfuric acid; an alkylsulfonic acid; and an arylsulfonic acid; and
an alcohol selected from the group consisting of: C₁-C₈ linear alcohol and C₃-C₈ branched alcohol and mixtures thereof;
combining said pre-treated lignin-derived material with said acidic composition into an esterification reaction mixture;
heating up said esterification reaction mixture to a temperature ranging from 25° C. to 120° C.; and
allowing sufficient time for an esterification reaction to occur to yield an esterified composition comprising said at least one esterified lignin derivative;
wherein said at least one esterified lignin derivative has the following characteristics: low viscosity, boiling point within the range of diesel (approximately 160-350° C.), strong film-forming properties, and is miscible in a diesel fuel.
